(19) United States
(12) Patent Application Publication
(10) Pub. No.: US 2006/0026023 A1
(43) Pub. Date: Feb. 2, 2006

(54) Method of leasing an automobile

(76) Inventors: Donald Ray Cooley JR., Portland, OR (US); Dhryl Anton, Portland, OR (US)

Correspondence Address: KOLISCH HARTWELL, P.C., 200 PACIFIC BUILDING, 520 SW YAMHILL STREET, PORTLAND, OR, 97204, US

(21) Appl. No.: 11/133,931

(22) Filed: May 20, 2005

Related U.S. Application Data
(60) Provisional application No. 60/598,751, filed on Aug. 2, 2004.

(51) Int. Cl. G06Q 99/00

(52) U.S. Cl. 705/1

(57) ABSTRACT

A method of leasing an automobile from a lessor to a lessee, includes the steps of equipping an automobile with a remotely controlled device that can be used to control the automobile, and agreeing to lease the automobile to a lessee without regard to the creditworthiness of the lessee. The equipping step includes a remotely controlled device that can be used to control the automobile, and the agreeing step involves allowing the lessee to lease the automobile if the lessee performs certain preselected, required tasks. The equipping step may also include a communicator that allows the lessor and lessee to communicate with each other after the lessee has leased the automobile. One of the preselected, required tasks of the agreeing step is to make a periodic payment, and wherein the equipping step includes a communicator that allows the lessee to make a payment that is accepted by the lessor.

### CROSS-REFERENCE TO RELATED APPLICATIONS

This application claims priority under 35 U.S.C. § 119(e) to U.S. Provisional Patent Application Ser. No. 60/598,751, filed Aug. 2, 2004 and entitled “System and Method for Tracking and Controlling a Rented Item”, which is incorporated herein by reference.

### TECHNICAL FIELD

The field of the invention relates to systems and methods for renting, leasing and selling automobiles.

### BACKGROUND

Conventional transactions in which consumers purchase, rent or lease automobiles involves a credit-approval process as a condition of the transaction. The seller, renter or lessor investigates the potential consumer's credit and agrees to sell, rent or lease the automobile based upon that determination.

The present invention includes a system and method for selling, renting or leasing an automobile without any regard for the creditworthiness of the automobile consumer.

### SUMMARY OF THE INVENTION

The invention may be characterized as a method of leasing an automobile from a lessor to a lessee, including the steps of equipping an automobile with a remotely controlled device that can be used to control the automobile, and agreeing to lease the automobile to a lessee without regard to the creditworthiness of the lessee. The equipping step includes a remotely controlled device that can be used to control the automobile, and the agreeing step involves allowing the lessee to lease the automobile if the lessee performs certain preselected, required tasks. The equipping step may also include a communicator that allows the lessor and lessee to communicate with each other after the lessee has leased the automobile. One of the preselected, required tasks of the agreeing step is to make a periodic payment, and wherein the equipping step includes a communicator that allows the lessee to make a payment that is accepted by the lessor.

### BRIEF DESCRIPTION OF THE DRAWINGS

FIG. 1 is a schematic block diagram showing a version of the method of the invention.

FIG. 2 is a schematic block diagram showing another version of the method of the invention.

FIG. 3 is a schematic block diagram showing a version of the system of the invention.

FIG. 4 is a schematic block diagram showing another version of the system of the invention.

FIG. 5 is a schematic block diagram showing another version of the method of the invention.

FIG. 6 is a schematic block diagram showing another version of the system of the invention.

FIG. 7 is an isometric view of an automobile with an automobile-control mechanism used with and included in the method and system of the invention.

### DETAILED DESCRIPTION

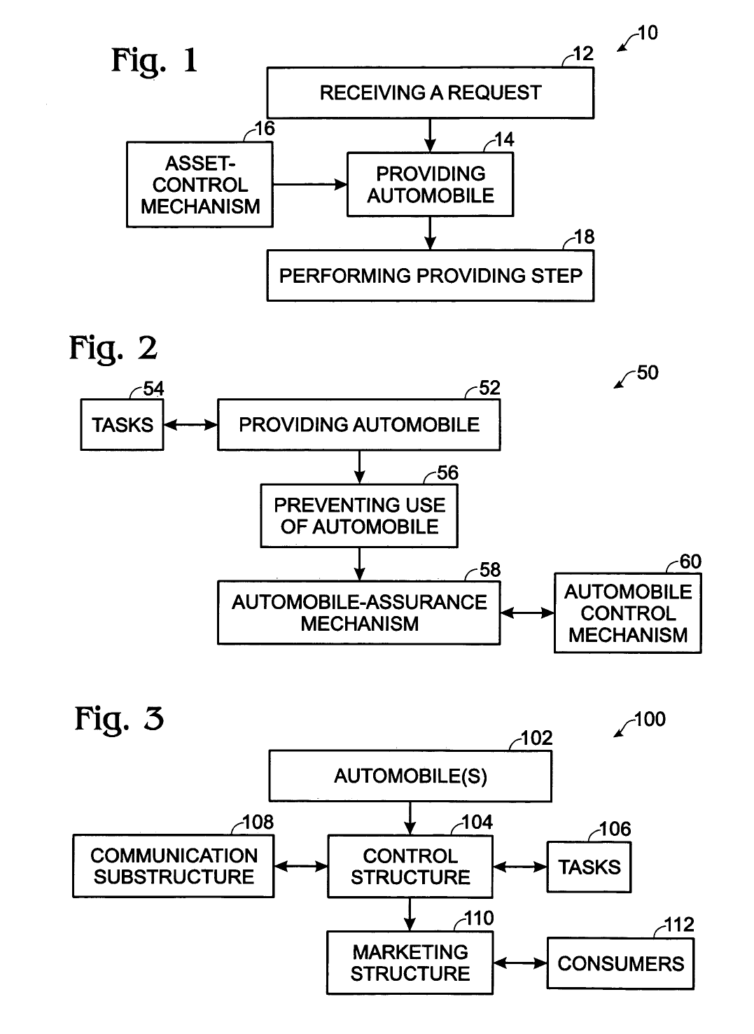

Referring to FIG. 1, there is shown a method 10 of allowing an owner to permit use of an automobile by a requestor regardless of creditworthiness. A first step 12 involves receiving a request from a requestor, followed by a second step 14 of providing the automobile to the requestor. The providing step is done by requiring the requestor to agree to perform preselected tasks required by the owner, and by preventing the requestor from using the automobile if the requestor does not perform at least one of the preselected tasks. The preselected tasks may include monthly payment obligations to the owner, as well as maintaining automobile insurance. The idea is for the owner to require tasks that are pertinent to the permitted use of the automobile.

Still referring to FIG. 1, the preventing step is performed by using an asset-control mechanism 16 that allows the owner to control the automobile if the requestor does not perform at least one of the preselected tasks. Method 10 also includes step 18 of performing providing step 14 without any regard for the creditworthiness of the requestor.

The asset-control mechanism may include any mechanism that can be controlled remotely or by a timing-control device, and that can be suitably coupled to the automobile to prevent an individual (such as a requestor, renter, lessee, purchaser) from using it. Suitable coupling of such a mechanism may include coupling to the wheels, door-lock mechanism, ignition or engine-related controls.

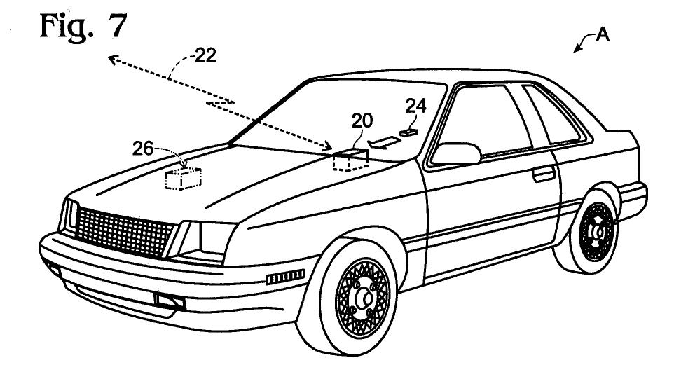

Referring ahead for a moment to FIG. 7, there is shown an automobile A which includes one version of asset-control mechanism 16 as a control device 20. That control device is constructed to afford two-way communication (shown schematically by the double-arrowed line 22) between the device and the owner of the automobile. Also shown is portable communication device 24 which may take the form of a card. The idea is for the requestor to possess the card and use it by inserting it into control device 20, allowing the requestor to use automobile A. The card is one example of several proposed by this invention. Other forms of device 24 (undepicted) may be: (i) a biometric device or other suitable customer identifier (in which the customer presses their thumb on a pad located on control device 20, which is constructed to read the impression of the customer's thumbprint left on the pad and determine whether the customer is an authorized user of the automobile); or (ii) a keypad entry device located on and in communication with control device 20, allowing the customer to enter a password/personal-identifier code. By using communication device 24, the invented system and method can verify that the customer is an authorized customer on an ongoing basis. For example, if the customer does not meet a fourth monthly payment obligation after meeting the first three, authorization can be withdrawn immediately and the customer will no longer be able to use the automobile. The mechanism to accomplish this is to withdraw that customer authorization so that control device 20 will not respond when the customer uses the communication device to begin operating the automobile. The automobile owner is in communication with control device 20 via the two-way communication shown by arrow 22.

Another version of asset-control mechanism 16 may be located under the hood of automobile A, such as device 26. The idea behind FIG. 7 is to show that asset-control mechanism 16 may be placed in various locations within automobile A to meet the functional requirements of being suitably coupled to automobile A so that it can prevent the requestor from using the automobile. That coupling may take the form of communication with the automobile-locking system (so that the requestor may not enter), or communication with the automobile ignition, transmission, or other engine-related operations (so that the requestor may not operate the automobile).

Referring now to FIG. 2, another version of the invention is shown by a method 50 of assuring that an automobile is being used by an authorized user. The method includes a step 52 of providing the automobile to the authorized user. That step is performed by requiring the user to agree to perform at least one preselected task without any regard at any time for the creditworthiness of the user. Another step 56 involves preventing the user from using the automobile if the user does not perform the at least one preselected task. The concept of tasks is shown schematically at box 54, and those tasks may include payment obligations, automobile insurance obligations, and others as described above in connection with the first version of the invention.

Still referring to FIG. 2, the preventive step is performed by using automobile-assurance mechanism 58 and an automobile-control mechanism 60. Mechanism 58 allows the owner to remotely control the automobile if the user does not perform the at least one preselected tasks. Mechanism 60 allows the owner to block operation of the automobile by the requestor. Blocking operation may include locking the automobile doors so that the user cannot enter, locking the automobile wheels so that the user cannot drive the automobile, and disabling the automobile ignition or other engine-related control mechanism so that the user cannot start or use the automobile engine.

Referring now to FIG. 3, there is shown an automobile marketing system 100 that allows a marketer to market automobiles to consumers. System 100 includes a supply 102 of automobiles and control structure 104 coupled to each of the automobiles. A series of tasks shown schematically at 106, and communication substructure 108 are involved with control structure 104 and will be described further after completing this general description. System 100 also includes marketing structure 110 designed to communicate to consumers (shown schematically at 112) about the automobiles and about how a consumer can obtain access to a desired one of the automobiles without regard to the creditworthiness of the consumer.

Still referring to FIG. 3, control structure 104 allows the marketer to control access to a desired automobile by a consumer. Control structure 104 also allows the marketer to control access to that automobile based upon whether the consumer performs certain preselected, required tasks 106, such as the tasks defined above. Control structure 104 also includes communications substructure 108 allowing the marketer and consumer to communicate with each other after the consumer has obtained access to the automobile. That communication may include exchange of any information that is pertinent to the automobile transaction, including payment by the consumer to the marketer to meet the consumer's monthly payment obligation.

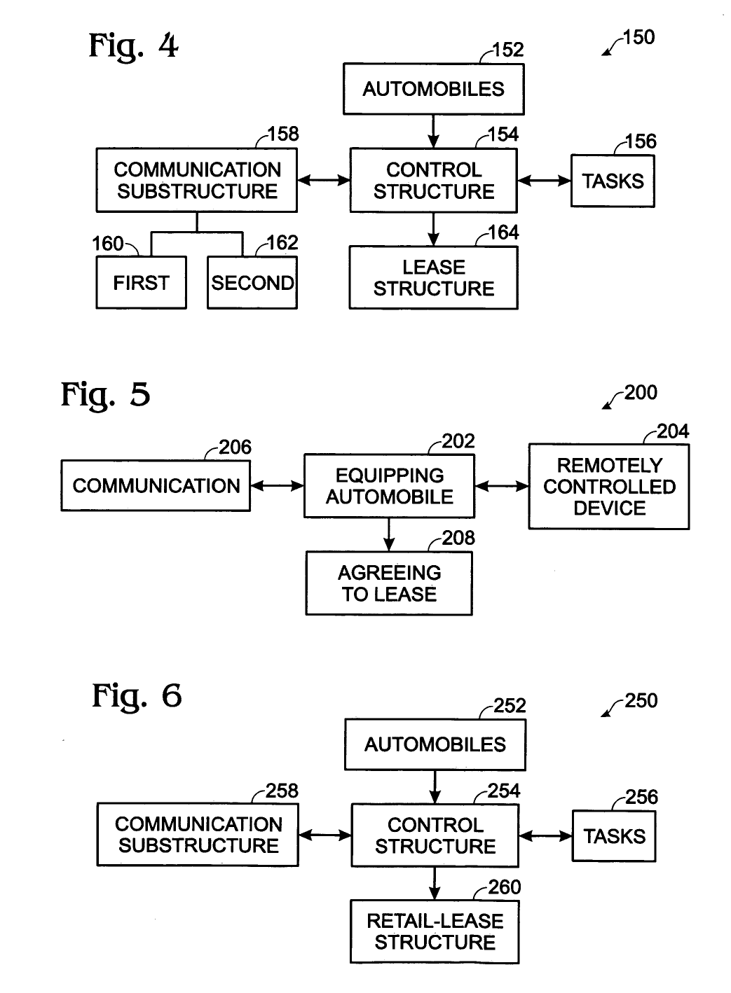

Referring to FIG. 4, the invention may also be characterized as an automobile lease system 150 that includes a supply 152 of automobiles, and control structure 154 coupled to each of the automobiles. Box 156 schematically illustrates certain tasks to be performed by automobile lessees, and control structure 154 also includes communication substructure 158. That communication substructure may include first-communication substructure 160 and second-communication substructure 162. First-communication substructure 160 allows the lessor and lessee to communication with each other after the lessee has leased the automobile. Second-communication substructure 162 allows the lessor to communicate with the automobile, such as by unlocking the door of the automobile to enter it.

Still referring to FIG. 4, automobile lease system 150 also includes lease structure 164 which may take the form of printed or electronic material that defines the lease relationship, and among other things, the number of tasks 156 that the lessee must perform to meet the obligations of lease structure 164.

Referring to FIG. 5, the invention may also be characterized as a method 200 of leasing an automobile from a lessor to a lessee. That method includes step 202 of equipping an automobile with a remotely controlled device 204 that can be used to control the automobile. The concept of communication between the lessor and lessee is shown schematically at box 206, which box is meant to signify that the equipping step also includes use of a communicator to allow the lessor and lessee to communicate with each other after the lessee has leased the automobile. Method 200 also includes step 208 of agreeing to lease the automobile to the lessee without regard to the creditworthiness of the lessee.

Referring to FIG. 6, a retail-automobile leasing system 250 is shown, and includes a supply 252 of automobiles, and control structure 254 coupled to each of the automobiles. Automobile lessees using the system are required to perform tasks shown schematically at 256, and control structure 254 includes communication substructure 258 to afford communication between the automobile lessee and lessor about matters pertinent to the automobile lease, including monthly payment obligations by the lessee.

Still referring to FIG. 6, retail-automobile leasing system 250 also includes retail-lease structure 260 which may take the form of printed or electronic material that defines the lease relationship, and among other things, the number of tasks 256 that the lessee must perform to meet the obligations of retail-lease structure 260.

The specific embodiments of a method of allowing an owner to permit use of an automobile by a requestor regardless of creditworthiness as disclosed and illustrated herein are not to be considered in a limiting sense as numerous variations are possible. The subject matter of this disclosure includes all novel and non-obvious combinations and subcombinations of the various features, elements, functions and/or properties disclosed herein. No single feature, function, element or property of the disclosed embodiments is essential. The following claims define certain combinations and subcombinations which are regarded as novel and non-obvious. Other combinations and subcombinations of features, functions, elements and/or properties may be claimed through amendment of the present claims or presentation of new claims in this or a related application. Such claims, whether they are different, broader, narrower or equal in scope to the original claims, are also regarded as included within the subject matter of the disclosure.

We claim:

1. A method of leasing an automobile from a lessor to a lessee, comprising:
equipping an automobile with a remotely controlled device that can be used to control the automobile;
agreeing to lease the automobile to a lessee without regard to the creditworthiness of the lessee.

2. The method of claim 1, wherein the equipping step includes a remotely controlled device that can be used to control the automobile, and the agreeing step involves allowing the lessee to lease the automobile if the lessee performs certain preselected, required tasks.

3. The method of claim 1, wherein the equipping step also includes a communicator that allows the lessor and lessee to communicate with each other after the lessee has leased the automobile.

4. The method of claim 2, wherein the equipping step also includes a communicator that allows the lessor and lessee to communicate with each other after the lessee has leased the automobile.

5. The method of claim 4, wherein one of the preselected, required tasks of the agreeing step is to make a periodic payment, and wherein the equipping step includes a communicator that allows the lessee to make a payment that is accepted by the lessor.

6. The method of claim 5, wherein one of the preselected, required tasks of the agreeing step is to make a periodic payment, and wherein the equipping step includes a communicator that allows the lessee to make a payment to a third party that is accepted by the lessor.
